(19) United States
(12) Patent Application Publication
(10) Pub. No.: US 2007/0051717 A1
(43) Pub. Date: Mar. 8, 2007

(54) Scent diffuser used with low-temperature dehydrated plant powders

(76) Inventor: Chao-Fu Cheng, Banciao City (TW)

Correspondence Address: CHARLES E. BAXLEY, ESQ., 90 JOHN STREET, THIRD FLOOR, NEW YORK, NY, 10038, US

(21) Appl. No.: 11/210,533

(22) Filed: Aug. 24, 2005

(51) Int. Cl. H05B 11/00

(52) U.S. Cl. 219/201

(57) ABSTRACT

A scent diffuser used with a low-temperature dehydrated plant powder includes: a scent diffuser body having a base and a lid; a heating basin being made by a thermal conductive material and having a three-dimensional heating groove disposed on the surface at the top of the heating basin and a heating device installed at the bottom of the heating basin; a temperature and time controller electrically connected to a circuit of the heating device for controlling and adjusting the action and temperature of the heating device, and the heating groove is provided for placing a powder of a natural herbaceous or woody plant by a low-temperature dehydration process, and the powder is heated by the heating device, such that the heating basin continues heating the powder contained therein to release the aroma of the natural herbaceous or woody plant.

### BACKGROUND OF THE INVENTION

1. Field of the Invention

The present invention relates to a scent diffuser, and more particularly to a design having a heating basin body with a special three-dimensional groove, such that the design provides a maximum capacity for a minimum area, and the powders of a natural herbaceous plant (such as lavender and rosemary) or a woody plant (such as sandalwood and agalloch) made by a low-temperature dehydrating process are heated evenly for a long time to achieve the purpose of releasing the aroma of the natural herbaceous or woody plant.

2. Description of the Related Art

In recent years, aromatic treatments become popular. Aromatic treatments use the aromatic stimulation of different essential oils to refresh our weariness, release our pressure, energize our body, relax our tension, and also create different atmospheres. The most extensively used aromatic treatment is carried out by a liquid scent diffuser, wherein the essential oil is contained in the scent diffuser and absorbed by a wick; the top of the scent diffuser is heated directly or indirectly by other electric heat device to evaporate the liquid essential oil and release the aroma of the essential oil.

In general, an essential oil is extracted from the roots, stems, leaves, flowers, peels, or fruits of a plant, which is a kind of oil with special aroma. Since the content of an essential oil existed in a plant is very little, therefore it requires a lot of plants to produce a small quantity of essential oil. For example, it requires a metric ton of rose petals to produce 0.5 liter of rose essential oil, and thus the manufacturing cost is very high. Furthermore, a large quantity of dregs is produced after the manufacture, and thus creating an adverse effect to the environment. The quality of liquid essential oils is uneven, and some of the unworthy manufacturers use chemical organic solvents (such as isopropyl alcohol) with a high toxicity and a poor quality to dilute the essential oil and lower the cost. These poor-quality essential oils not only fail to achieve the effect of the aromatic treatments, but also vaporize the organic solvent and cause damages to our health. However, consumers cannot distinguish the quality of the essential oils from their appearance. The essential oil added with a poor-quality chemical organic solvent has a high risk of causing a high temperature or even an explosion. If consumers are not using these essential oils with care, then it will cause damages to our life or properties.

Some manufacturers mix scent powders with a solidifier in a certain specific proportion to produce a scent in a conical or other shape. When the scent is used, the scent is burned directly to release the aroma by combusting the scent. Since the scent and solidifier will produce a waste smoke after the combustion and smoke the objects in a room, therefore these scents have a drawback on smokes.

### SUMMARY OF THE INVENTION

Therefore, it is a primary objective of the present invention to overcome the shortcomings of the uneven quality of the prior art liquid essential oils and provides an effective and feasible solution to the safety issue. The present invention uses a natural substance such as the roots, stems, leaves, flowers, peels, or fruits of plants to produce a powder by a low-temperature dehydration process, and then indirectly heat the powder by a scent diffuser to achieve the effect of releasing the aroma of the natural herbaceous or woody plants.

To achieve the foregoing objective, a scent diffuser used with a low-temperature dehydrated plant powder in accordance with the present invention comprises: a scent diffuser body having a base and a lid; a heating basin being made by a thermal conductive material and having a three-dimensional heating groove disposed on the surface at the top of the heating basin and a heating device installed at the bottom of the heating basin; a temperature and time controller electrically connected to a circuit of the heating device for controlling and adjusting the action and temperature of the heating device, and the heating groove is provided for placing a powder of a natural herbaceous or woody plant by a low-temperature dehydration process, and the powder is heated by the heating device, such that the heating basin continues heating the powder contained therein to release the aroma of the natural herbaceous or woody plant steadily.

The powder made from a natural substance such as the roots, stems, leaves, flowers, peels, and fruits of a natural plant by a low-temperature dehydration process not only can be carried out in mass production, save the manufacturing cost and lower the price, but also can avoid using any chemical additives or solidifier in the product. Therefore, the present invention will not harm our body or cause damages to the environment. In addition, consumers can grind the natural material into a powder form by themselves by using an electric grinder (such as a coffee bean grinder) after purchasing the low-temperature dehydrated herbaceous and woody plants. The consumers can have a better control on the quality of the product by the DIY process. The powder is heated with a low temperature by a scent diffuser (about 100° C. for herbaceous plants and 200° C. for woody plants) to achieve the purpose of releasing the aroma of the herbaceous or woody plants easily. Thus, the invention can prevent possible explosions caused by heating a poor-quality essential oils or smokes produced after the combustion of the scent. The present invention definitely meets the requirements for health, safety, environmental protection, and economic effectiveness.

### BRIEF DESCRIPTION OF THE DRAWINGS

FIG. 1 is an exploded view of the present invention;

FIG. 2 is another exploded view of the present invention;

FIG. 3 is a perspective view of the present invention;

FIG. 4 is a perspective view of a heating basin of the present invention;

FIG. 5 is another perspective view of a heating basin of the present invention;

FIG. 6 is a cross-sectional view of Section A-A as depicted in FIG. 4;

FIG. 7 is an enlarged view of a part of FIG. 6;

FIG. 8 is a schematic view of heating a scent diffuser according to the present invention; and

FIG. 9 is a schematic view of cleaning the heating basin of the present invention.

### DETAILED DESCRIPTION OF THE PREFERRED EMBODIMENTS

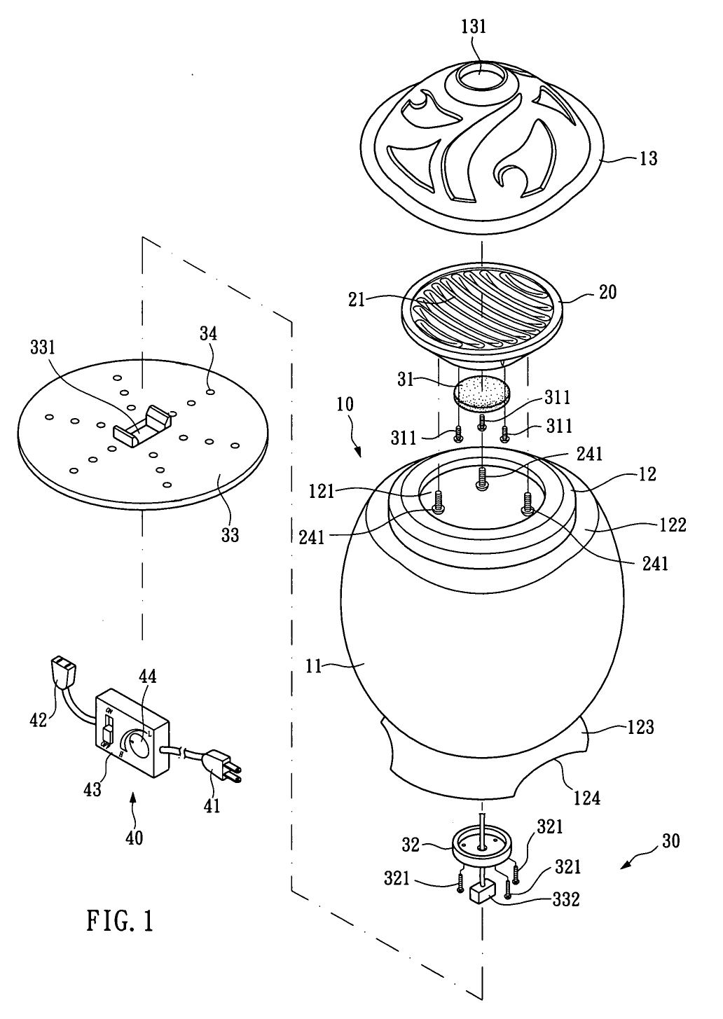

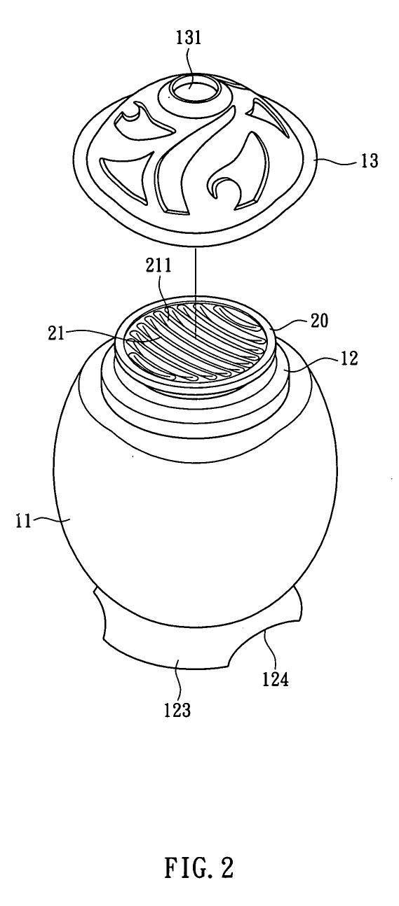

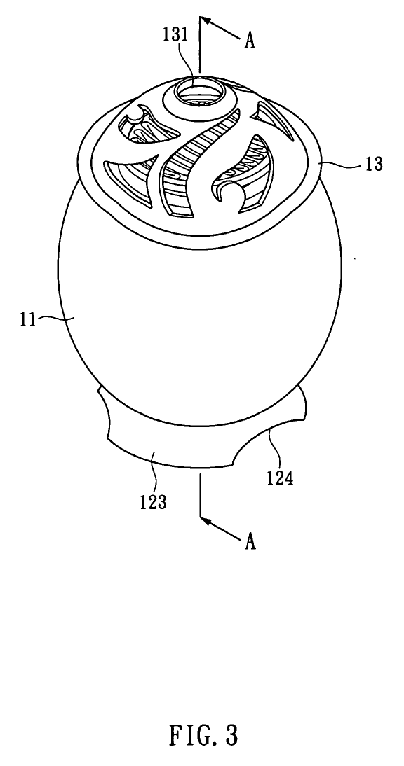

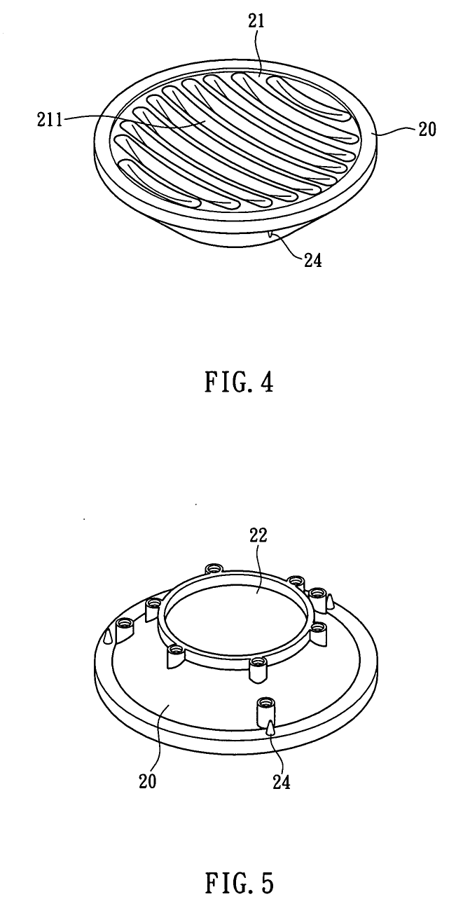

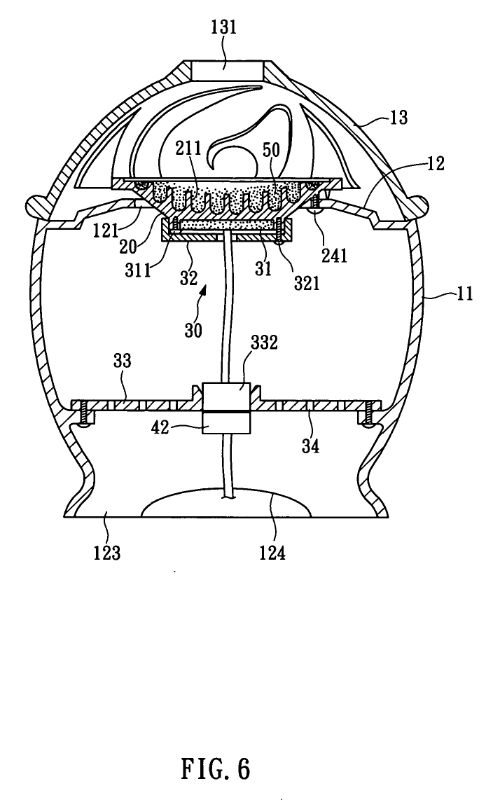

Referring to FIGS. 1 to 5, a scent diffuser used with a low-temperature dehydrated plant powder comprises the following elements:

A scent diffuser body 10 includes a hollow base 11 in the middle and a fixed base 12 disposed at the top of the base 11, and the fixed base 12 includes a through hole 121 at the center of the fixed base 12 and a latch edge 122 tapered from the periphery of the fixed base 12, and the base 11 includes a lower chassis 123 disposed at the bottom of the base 11, and the lower chassis 123 includes at least one air inlet 124 disposed along the periphery of the lower chassis 123, and a cover 13 is provided for being movably coupled onto the fixed base 12 and has at least a scent diffusing hole 131.

A heating basin 20 is a circular basin made of a thermal conductive material such as an aluminum alloy and having a heating groove 21 at the concave top surface of the heating basin 20, and the heating groove 21 is concave and has a larger depth in the middle, and the heating groove 21 includes at least one thermal conductive groove 211 disposed in parallel with each other, and the cross-section of the thermal conductive groove 211 is in a circular concave shape, and the depth of the thermal conductive groove 211 become increasingly larger from both ends to the middle, and the heating basin 20 includes an accommodating groove 22 disposed at the bottom of the heating basin 20, and a Teflon layer 23 is coated onto the surface of the heating basin 20; wherein a conical footer 24 is protruded from the periphery of the bottom of the heating basin 20, and the heating basin 20 is secured into the through hole 121 by a screw device 241, and the conical footer 24 can prop against the periphery of the through hole 121, so that a gap is maintained between the heating basin 20 and the through hole 121 for producing an air convection in the base 11.

A heating device 30 includes an electric heat plate 31 installed in the accommodating groove 22 and the electric heat plate 31 is fixed into the accommodating groove 22 by a screw 311. A heat insulating basin 32 is made of a heat insulating material such as ceramic fibers for covering the accommodating groove 22 and the electric heat plate 31 and fixed onto the bottom of the accommodating groove 22 by a plurality of screws 321; wherein the base 11 includes a fixed board 33 disposed therein, and the fixed board 33 includes a socket hole 331 for installing a safety socket 332, and the safety socket 332 is a magnetic safety socket and electrically connected to the circuit of the electric heat plate 31, and the fixed board includes at least one ventilation hole 34.

A temperature and time controller 40 includes a plug 41 connected to an electric power supply and disposed at an end, and a connecting end 42 disposed on the other end for movably connecting the safety socket 332. The temperature and time controller 40 installs a timer power switch 43 and a temperature adjusting switch 44 for controlling and adjusting the operating time and temperature of the heating device 30.

Referring to FIGS; 6 and 7, the heating groove 21 is provided for containing or filling a powder 50 of natural herbaceous or woody plant made by a low-temperature dehydration process. Since the heating groove 21 is in a concave shape and has a larger depth in the middle, and the depth of the bottom of the thermal conductive groove 211 becomes increasingly larger from both ends to the middle, therefore, the heating basin 20 can keep the powder inside, and thus the powder will not fall out from the heating basin 20 easily by external forces.

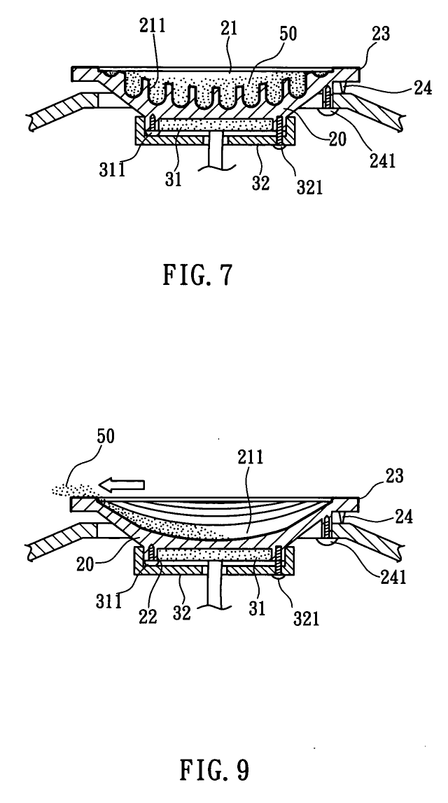

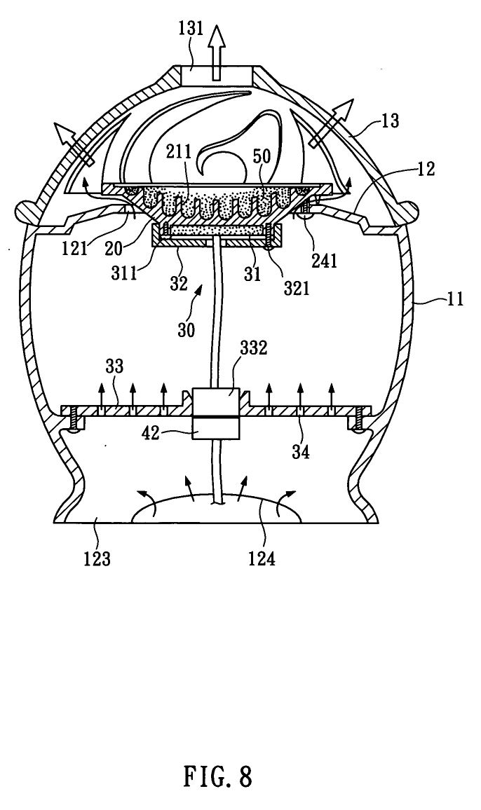

Referring to FIG. 7 and 8, the action of the heating device 30 can keep on heating the powder to achieve the purpose of releasing the aroma of the essential oils of natural herbaceous or woody plants steadily. The thermal conductive groove 211 on the heating basin 20 can increase the contact area of the basin body and the powder 50 to reduce the time of heating by a constant temperature and achieve the effect of steadily releasing the aroma of the powder 50 for a long time at the constant temperature. When the powder 50 on the heating basin 20 releases aroma, the cold and hot air produce a convection, and the cold air enters from the air inlet 124 at the bottom of the base 11 through the ventilation hole 34 to the fixed board 33, and then through the gap between the heating basin 20 and the through hole 121 to the heating basin 20. The hot air carrying the aroma of the essential oil of the plant is discharged from the scent-diffusing hole 131 at the top of the cover 13, and it also can lower the temperature at the surface of the base 11 at the same time.

Referring to FIG. 9, since the heating groove 21 and the thermal conductive groove 211 come with a special curved design, and the cross-section of the thermal conductive groove 211 is in a circular concave shape, therefore a user just needs to use a brush to sweep along the direction of the thermal conductive groove 211 to clean up the dregs or residues of the scent after the powder completely releases its aroma. Furthermore, the heating basin 20 includes a Teflon layer 23 coated on the surface of the heating basin 20 for preventing any tars or sticky substances remained on the surface, so as to keep the heating basin 20 clean. The cross-section of the thermal conductive groove 211 could be in a concave V-shape or a concave rectangular shape.

The temperature and time controller 40 installs a timer power switch 43 and a temperature-adjusting switch 44 for controlling the operating time and temperature of the heating device 30, and the connecting end 42 is movably connected to the safety socket 332. Such arrangement allows a quick installation or removal of the temperature and time controller 40 and facilitates the storage of individual components as well as giving an artistic look to the overall base 11. If the scent diffuser is in use and the cable of the temperature and time controller 40 is pulled by external forces, or the base 11 is toppled, the connecting end 42 will automatically disconnect the power of the safety socket 332 to avoid accidents.

The natural substances including the roots, stems, leaves, flowers, peels, and fruits of a plant according to the present invention is dehydrated by a low-temperature dehydration process, and the content of the essential oils can be kept. These substances are then ground into powder, not only making a mass production possible, saving the manufacturing cost and lowering the price, but also avoiding the use of chemical additives or solidifiers, and thus preventing any damages to our health and environment. Furthermore, consumers can use an electric grinder (such as a coffee bean grinder) to grind the herbaceous or woody plants by themselves after purchasing the low-temperature dehydrated herbaceous or woody plants. The DIY process can assure the quality of the product. With a low temperature heating (about 100° C. for herbaceous plants and 200° C. for woody plants) by a scent diffuser, the purpose of releasing the aroma from the natural herbaceous or woody plants can be achieved easily. The present invention also can prevent the risk of an explosion caused by the evaporation of a poor-quality of essential oil and can overcome the drawbacks of producing harmful smokes. Therefore, the present invention definitely meets the requirements for health, safety, environmental protection, and economic effectiveness.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scent diffuser used with low-temperature dehydrated plant powders, comprising:
a heating basin, made of a thermal conductive material in a disk shape, and having a heating groove disposed on a concave top surface of said heating basin;
at least one thermal conductive groove disposed at the bottom of said heating groove; and
a heating device being coupled to the bottom of said heating basin.

2. The scent diffuser used with low-temperature dehydrated plant powders of claim 1, wherein said heating basin includes an accommodating groove at the bottom of said heating basin for accommodating said heating device.

3. The scent diffuser used with low-temperature dehydrated plant powders of claim 1, wherein said heating groove is in a circular concave shape having a larger depth in the middle.

4. The scent diffuser used with low-temperature dehydrated plant powders of claim 1, wherein said thermal conductive groove has a depth becoming increasingly larger from both ends to the middle.

5. The scent diffuser used with low-temperature dehydrated plant powders of claim 4, wherein said thermal conductive groove has a cross section in a circular concave shape.

6. The scent diffuser used with low-temperature dehydrated plant powders of claim 4, wherein said thermal conductive groove has a cross section in a V-shape.

7. The scent diffuser used with low-temperature dehydrated plant powders of claim 4, wherein said thermal conductive groove has a cross section in a rectangular shape.

8. The scent diffuser used with low-temperature dehydrated plant powders of claim 1, wherein said heating basin includes at least one conical footer protruded from the periphery of the bottom of said heating basin.

9. The scent diffuser used with low-temperature dehydrated plant powders of claim 1, wherein said heating basin is coated with a Teflon layer on the surface of said heating basin.
